(19) United States
(12) Patent Application Publication
(10) Pub. No.: US 2009/0096743 A1
(43) Pub. Date: Apr. 16, 2009

(54) DIGITAL PICTURE FRAME WITH PERIPHERAL AUDIO INPUT

(76) Inventors: Sandro F. DalPorto, Ladera Ranch, CA (US); Tracy Silletto, Ladera Ranch, CA (US); Yu-Ming Wang, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/872,570

(22) Filed: Oct. 15, 2007

(51) Int. Cl. G09G 3/36

(52) U.S. Cl. 345/104

(57) ABSTRACT

An apparatus for displaying digital image data includes a display panel of a plurality of rows and columns of pixels. The selected ones of the pixels are activatable to form a visual representation of the digital image data. The apparatus further includes a memory module for storing the digital image data, and an image processing unit for converting the digital image data to a display signal transmitted to the display panel. There is also an audio input port receptive of a peripheral audio connector in electrical communication with an external signal source such as a portable media player. The apparatus includes an acoustic transducer for reproducing an audio signal from the external signal source.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to image display devices. More particularly, the present invention relates to digital picture frames with peripheral audio input.

2. Related Art

Photographs are taken for a variety of artistic and/or practical purposes, including news reporting and documenting, advertisements, entertainment, story telling, and so forth. The most common personal use of photographs, however, is to visually preserve particularly memorable life events such as weddings, a child's first steps, and vacations in exotic locales. Many find comfort in viewing photographs that serve as reminders of more fun, enjoyable, and perhaps better times. Reminiscing about the moments depicted in photographs may bring back all of the emotions the viewer has associated therewith, and allowing an escape from the drudgery of everyday life, albeit only for a short time. Still others take photographs so that the happenings of their lives are preserved for posterity.

Earlier photography employed film cameras, in which an image is exposed to a film that is processed into a negative. Various well-known chemical processes are used to develop exposed film into the negative. The negative is projected onto photographic paper, which results in a photographic print. Automated photo processing techniques encouraged even casual photographers to amass a large collection of prints relating to a wide variety of subjects and events. Related collections of individual prints are typically catalogued in an album, while particularly well-composed or striking pictures may be individually framed and mounted. Framed pictures may serve as décor for home interiors, imparting a personalized appearance thereto. Because of material and development costs, however traditional film photography is becoming disfavored over digital photography, particularly for casual purposes as those previously described. Although the principles of image capture are substantially the same in digital cameras as in film cameras, instead of the film recording the exposure, an electronic sensor detects the image and records the same to a memory device. In order to view the images, the data on the memory device is typically transferred to a conventional personal computer. Alternatively, the images may be printed on specialized color photo printers to produce individual prints as in film photography, and handled in the same manner; the prints of the digital images may similarly be framed or catalogued in albums.

Although the output from current photo printers has resolution, color gamut, and overall image quality that match traditional film prints, high quality photo printers and their consumables are expensive. Furthermore, the difficulty associated with replacing prints in frames effectively limits the number of photographs that can be exhibited in a particular space. Digital photo frames were developed to address these deficiencies, in which multiple digital photographs are stored and displayed. Most configurations retain the general size, shape and aesthetics of conventional photo frames, thereby maintaining its suitability for household decorative applications. A variety of pictures are displayed at the direction of user control or displayed automatically in a slideshow-like manner. Upon capturing the images with the camera, the digital picture data or files are copied to a memory accessible by the digital picture frame. In some configurations, the memory is internal to the digital picture frame and not removable. With such configurations, digital picture data is typically transferred from the digital camera or the computer via a cable. Alternatively, the memory is removable, and may be the same media as that inserted in the camera.

A number of features in addition to the basic digital picture display functionality have been developed for digital picture frames, and among the most common of such additional features is audio playback. Typically, these enhanced digital picture frames include audio processors that generate sound signals reproduced by an onboard transducer or loudspeaker, and the sound signals are represented as digital audio files. In this regard, like the digital picture files, the digital audio files are stored on the memory accessible by the digital picture frame. Thus, it is possible for music or personalized speech to accompany the display of photographs.

Unfortunately, it is often unwieldy to copy digital audio files to the memory because of the large size of the files. Thus, music playback functionality is rarely used. As a further complication, digital audio files, particularly those purchased from online music services, have Digital Rights Management (DRM) restrictions placed thereon. Therefore, the playback of such digital audio files may be prohibited or impossible because the audio processor on the digital picture frame lacks the functionality to disengage the DRM restrictions. Even where the desired digital audio files could be played back, the order of playback may not necessarily have been as desired. The limited user interfaces provided by the digital picture frames rendered playback reordering difficult.

Accordingly, there is a need in the art for a digital picture frame with the capability to connect external audio sources such as digital media players through a peripheral audio input.

### BRIEF SUMMARY

In accordance with one embodiment of the present invention, an apparatus for displaying digital image data includes a display panel of a plurality of rows and columns of pixels. The selected ones of the pixels may be activatable to form a visual representation of the digital image data. Additionally, the apparatus includes a memory module for the digital image data. An image processing unit is utilized to convert the digital image data to a display signal, which is transmitted to the display panel for activating the selected ones of the pixels. The apparatus also includes an audio input port receptive of a peripheral audio connector that may be in electrical communication with an external signal source. Further, there may be an audio transducer connected to the audio input port. A first audio signal from the external signal source is reproducible by the audio transducer. In addition to first audio signal from the external signal source, there may be a second audio signal from an audio processor. The audio processor may convert a digital audio file stored on the memory module to the second audio signal. To switch between the first audio signal and the second audio signal, the apparatus may include an audio input switch connected to the audio processor and the audio input port. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a digital picture frame with peripheral audio input in accordance with one embodiment of the present invention;

FIG. 2 is a block diagram illustrating the modules of the digital picture frame including a display, a memory module, an image processing unit, an audio input port, and an audio transducer;

FIG. 3 is a side view of a particular embodiment of an audio input port and a peripheral audio connector receivably engageable therein;

FIG. 4 is a front view of a housing of the digital picture frame;

FIG. 5 is a side view of a housing of the digital picture frame in FIG. 4; and

FIG. 6 is a perspective view of the digital picture frame with a detachable decorative frame in accordance with an embodiment of the present invention.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions of the invention in connection with the illustrated embodiment. It is to be understood, however, that the same or equivalent functions and may be accomplished by different embodiments that are also intended to be encompassed within the scope of the invention. It is further understood that the use of relational terms such as first and second, top and bottom, and the like are used solely to distinguish one from another entity without necessarily requiring or implying any actual such relationship or order between such entities.

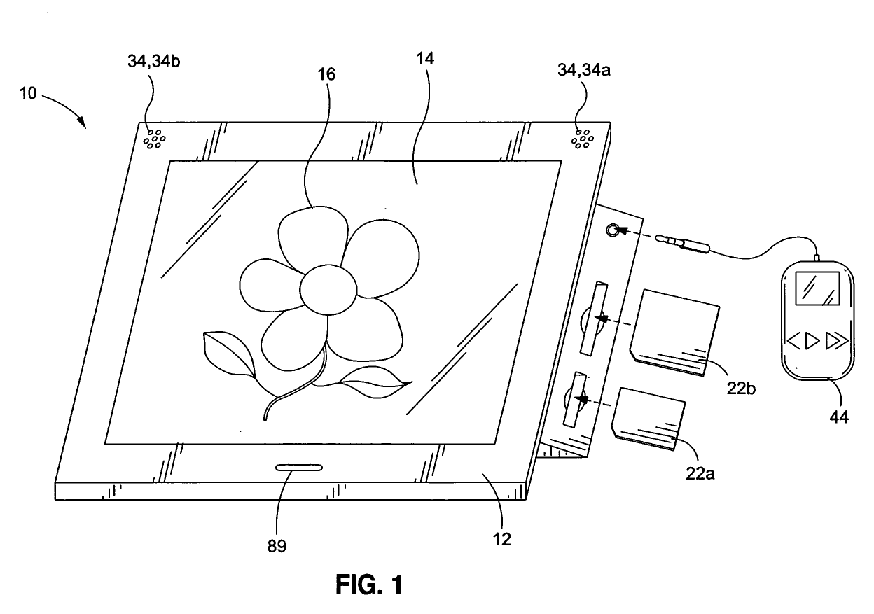

With reference to FIG. 1, a digital picture frame 10 in accordance with one embodiment of the present invention includes a generally rectangular housing 12 with a display screen 14 embedded or otherwise mounted thereto. The display screen 14 is generally defined by individual pixels that are arranged in rows and in columns, with specific pixels being activated by addressing the corresponding coordinates associated with the particular row and column. In further detail, each pixel is divided into three sub-pixels representative of red, green, and blue color components, and by specifying an intensity level for each of the sub-pixels, a color value for the pixel is set. Upon activating selected pixels as defined in a digital image data sequence, a visual representation 16 thereof is formed on the display 14. It is understood that the digital image data sequence includes color/intensity values for each of the pixels of the display screen 14. According to an embodiment of the present invention, the display screen 14 is an active matrix Thin Film Transistor (TFT) Liquid Crystal Display (LCD). Further, it is contemplated that the display screen 14 has a resolution of 480×234 pixels with an aspect ratio of 16:09. However, it will be appreciated that any other type of display screen 14 having any other resolution and size configuration may be readily substituted without departing from the scope of the present invention.

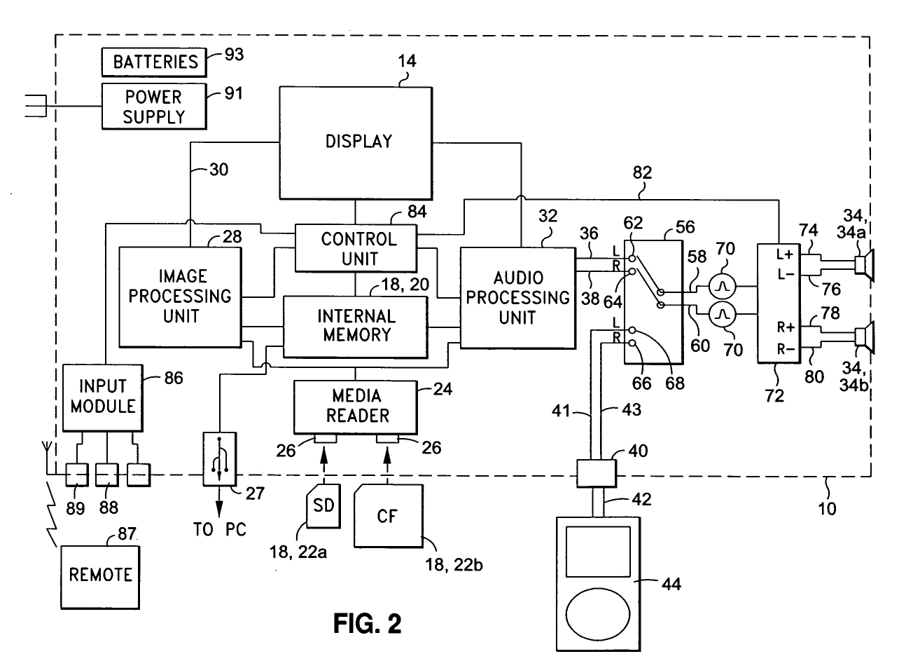

As shown in the functional block diagram of FIG. 2, the digital picture frame 10 includes a memory module 18 for storing the digital image data sequence. In one embodiment, the memory module 18 is an internal memory 20 that is embedded in the digital picture frame 10. Alternatively, the memory module 18 is a removable memory media 22, which may have a solid-state memory device such as Flash memory, or may have a hard disk drive. As shown, the removable memory media 22a conforms to the SecureDigital (SD) form factor, while the removable memory media 22b conforms to the CompactFlash (CF) form factor. These form factors are presented by way of example only and not of limitation, and thus it is understood that the removable memory media 22 may conform to other well-known form factors, including MultiMediaCard (MMC), MemoryStick (MS), xD-Digital Card, and so forth. The removable memory media 22 is received in a media reader 24, specifically, a slot 26 thereof. It is understood that the slot 26 is configured according to the specific form factor of the removable memory media 22 received therein. It is expressly contemplated that the media reader 24 be capable of simultaneously receiving more than one removable memory media 22. In this regard, the media reader 24 may have more than one slot 26.

The digital image data sequence may be transferred to the internal memory 20 via the removable memory media 22, or via a data transfer link 27 connectable to a data processing device such as a personal computer. In accordance with one embodiment, the data transfer link 27 may be a Universal Serial Bus (USB) connection, an Ethernet (LAN) connection, a wireless connection such as Bluetooth or WiFi, or any other data transfer link.

Whether stored on the internal memory 20, or the removable memory media 22, the digital image data sequence is retrieved from the respective memory module 18 by an image processing unit 28 prior to display. Specifically, the image processing unit 28 converts the digital image data sequence to a display signal 30 that is transmitted to the display screen 14. The display signal 30 is an electrical signal representative of the color and intensity values for each of the pixels, and the row and column coordinates thereof. It is understood that the digital image data sequence is stored on the memory module 18 as a conventional data file in conformance with one of a number of well-known file formats. Per such file formats, the digital image data sequence may be compressed by various compression algorithms. Amongst the most frequently utilized image data compression/formats is the Joint Pictures Expert Group (JPEG), though others such as Portable Network Graphics (PNG) and Graphics Interchange Format (GIF) may also be utilized. The image processing unit 28 decodes and decompresses such varied image data formats for conversion to the display signal 30.

In addition to being representative of still images, it is expressly contemplated that the digital image data sequence also be representative of video. More particularly, the digital image data sequence is understood to represent multiple frames of images that, when displayed in a synchronized sequence, appear as a video scene. As will be appreciated by those having ordinary skill in the art, the digital image data sequence of the video may be compressed and encoded with a variety of codecs, including the Motion Picture Experts Group-1 (MPEG-1), H.264, and so forth, and stored as a file according to a container format such as Audio Video Interleave (AVI), Quicktime (MOV), and MPEG-4 Part 14 (MP4). It is understood that the image processing unit 28 includes modules that deconstruct the container files and decodes the underlying video data or the digital image data sequence stored therein. Furthermore, it is contemplated that the image processing unit 28 includes other functionality that enhances or otherwise modifies the appearance of the displayed video scene.

The functions provided by the image processing unit 28 may be embodied as a dedicated graphics processing integrated circuit, which may further be separately embodied as a video processing integrated circuit and a still image processing integrated circuit. Alternatively, all aforementioned functions may be embodied on a general purpose Central Processing Unit (CPU) that may be programmed to perform the image processing functions.

As indicated above, the presentation of images and video on the digital picture frame 10 is often accompanied by music or other sounds. With further particularity, the digital picture frame 10 includes an audio processing unit 32 that converts a digital audio data sequence to an analog signal reproducible by audio transducers 34. According to one embodiment of the present invention, the audio processing unit 32 has a left output channel 36 and a right output channel 38, which may be connected to a left audio transducer 34a, and a right audio transducer 34b, respectively. It will be recognized by those having ordinary skill in the art, however, that the audio processing unit 32 may have a single output for mono audio, instead of stereo audio in the above configuration. The audio processing unit 32 retrieves the digital audio data sequence, which like the digital image data sequence, is stored on the memory module 18. Along these lines, the digital audio data sequence may be copied to the internal memory 20, or accessed from the removable memory media 22. Generally, the digital audio data sequence is a series of quantized values of voltages corresponding to discrete instants in time of a continuous, analog audio signal. Upon converting the values and outputting the same to the audio transducer 34 according to a predefined frequency, the analog audio signal is reproduced as sound. The digital audio data sequence is stored as an uncompressed WAV file, or more commonly, compressed and encoded as an MPEG-1 Layer 3 (MP3) file. Playback of sound need not be limited to MP3 or other audio-only data. As indicated above, the image processing unit 28 is capable of processing video, and the playback of video on the display screen 14 may be synchronized with accompanying audio. The audio processing unit 32 is understood to include a codec for the decoding of the digital audio data sequence, as well as a digital to analog converter for converting the digital values to an analog signal.

According to an embodiment of the present invention, the digital picture frame 10 includes an audio input port 40 capable of receiving a peripheral audio connector 42. The peripheral audio connector 42 is understood to be in electrical communication with an external signal source 44, which may be a portable digital audio player, a conventional CD player, a cassette player, or any other similar device. The external signal source 44 is understood to generate an analog audio signal that, when connected to the audio transducer 34, is reproduced as sound. As was the case for the output from the audio processing unit 32, the external signal source 44 is understood to have a left output channel 41 and a right output channel 43.

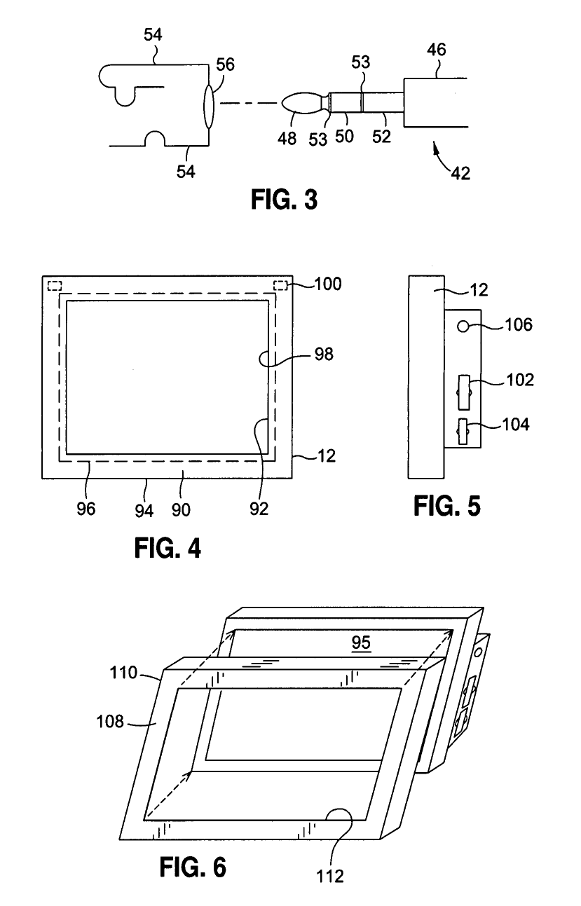

In accordance with an embodiment further illustrated in FIG. 3, the peripheral audio connector 42 is a conventional tip-ring-sleeve plug 46 having electrically isolated contacts for each of the separate outputs from the external signal source 44. As is well known in the art, the tip-ring-sleeve plug 46 is generally defined by a tip 48 typically designated for the left channel 41, a ring 50 typically designated for the right channel 43, and a sleeve 52 typically designated for ground. Insulation rings 53 composed of a non-conductive material are spaced between the tip 48 and the ring 50, and between the ring 50 and the sleeve 52 to provide electrical isolation therebetween. The audio input port 40 includes contact members 54 that receptively engage the tip-ring-sleeve plug 46 when it is inserted through an aperture 55. The aperture 55 is understood to establish an electrical connection to the sleeve 52, and is thus connected to ground. Although a particular embodiment of the audio input port 40 and the peripheral audio connector 42 has been described, it will be recognized by those having ordinary skill in the art that any other suitable audio interconnect structure may be readily substituted without departing from the scope of the present invention.

The sound that is ultimately reproduced by the transducer 34 is selectable between the signal generated by the audio processing unit 32 and the external signal source 44. Each signal source is connected to an analog switch 56 having a pair of output terminals 58, 60, a first pair of input terminals 62, 64 connected to the audio processing unit 32, and a second pair of input terminals 66, 68. With further particularity, the left output channel 36 from the audio processing unit 32 is connected to the first left input terminal 62, while the right output channel 38 from the audio processing unit 32 is connected to the first right input terminal 64. Additionally, the left input channel 41 from the external signal source 44 is connected to the second left input terminal 66, and the right input channel 43 from the external signal source 44 is connected to the second right input terminal 66. The analog switch 56 is understood to be a double-pole, double-throw type switch, in which the output terminals 58, 60 are connected to at least one of the first pair of input terminals 62, 64, or the second pair of input terminals 66, 68 at any given point. However, it will be recognized by those having ordinary skill in the art that alternative configurations may be substituted, such as, for example, a pair of single pole-single throw switches. The switch contact may be triggered to connect the output terminals 58, 60 to the second pair of input terminals 66, 68 upon the peripheral audio connector 42 being inserted in the audio input port 40.

Each of the output terminals 58, 60 are connected to a signal filter 70 to reduce any noise present in the signal. Numerous active filter circuits are known in the art, and a skilled practitioner will be capable of readily ascertaining the response characteristics of each to select a suitable one.

Although the external signal source 44 is generally understood to amplify its output audio signal to a level sufficient to drive the audio transducers 34, the output audio signal from the audio processing unit 32 may not be so sufficiently amplified. In this regard, the digital picture frame 10 includes a speaker driver 72 connected to the signal filters 70. The speaker driver 72 provides a left positive output 74 and a left negative output 76 both connected to terminals on the audio transducer 34a, and a right positive output 78 and a right negative output 80 both connected to terminals on the audio transducer 34b.

The external signal source 44 typically provides independent volume controls, so the speaker driver 72 may merely be set to predefined amplification factor. In some configurations, however, the external signal source 44 may provide a line-level signal with no volume level adjustments made thereto. Additionally, the audio processing unit 32 may likewise provide a line-level signal with no volume level adjustments. So that the sound produced by the transducers 34 has a sufficient and variable volume, the speaker driver 72 includes an amplification adjuster 82. In accordance with one embodiment, the amplification adjuster 82 of the speaker driver 72 is controlled by a central control unit 84. The central control unit 84 is connected to an input module 86, which receives user commands via keys or buttons 88. Alternative volume control techniques may be substituted, however, including user-actuated potentiometers and the like that increase or decrease the gain in the amplifiers in the speaker driver 72. In addition to the keys or buttons 88, user commands to the input module 86 may be provided by a remote control device 87. More particularly, there is a remote control receiver 89 capable of receiving input data from the remote control device 87 and translating the same to a corresponding user command capable of being interpreted by the input module 86. The remote control device 87 and the receiver 89 may communicate using a variety of well-known techniques, including infrared or radio frequency signals.

The central control unit 84 is also contemplated as managing the operation of the image processing unit 28 and the audio processing unit 32. By way of example only and not of limitation, the central control unit may provide the synchronization of playing back video and audio, calendar functions, alarm clock functions, and the like. Furthermore, various operational parameters such as playback speed, playback order, and the like may be set through configuration menus generated by the central control unit 84 and interfaced therewith via the input module 86.

Electrical power to the various above-described components of the digital picture frame 10 is provided by a power supply 91. The power supply 91 may be connected to a conventional 110V power outlet, or in the alternative, to batteries 93. In further detail, the power supply 91 may include various rectifier circuits, power regulator integrated circuits, and so forth. Those having ordinary skill in the art will be able to readily ascertain the necessary power supply circuitry.

As indicated above, the digital picture frame 10 is generally defined by a rectangular housing 12 that encloses the display screen 14. In addition to the display screen 14, however, the rectangular housing 12 is understood to enclose the various above-described components of the digital picture frame, including the image processing unit 28, the internal memory 18, the audio processing unit 32, the media reader 24, the audio input port 40, the analog switch 56, the signal filter 70, the speaker driver 72, and the audio transducer 34. With reference to FIG. 4, the rectangular housing 12 defines a slotted front face 90 with an interior edge 92 and an exterior edge 94. Though the physical dimensions of the display screen 14 extend to an outer edge 96, the active display region 95 is typically smaller. In the exemplary embodiment shown, the active display region is bounded by an outer edge 98, which is substantially co-incident with the interior edge 92 of the rectangular housing 12. The front face 90 additionally defines transducer holes 100 that effectively function as a speaker grille. Mounted behind the transducer holes 100 are the audio transducers 34.

With reference to FIG. 5, the rectangular housing 12 further defines a first media input slot 102 and a second media input slot 104, each of which provides access to for the removable memory media 22 to the media reader 24. Additionally, the rectangular housing 12 defines a circular audio input slot 106 for the peripheral audio connector 42 to access the audio input port 40. In this regard, the audio input slot 106 is understood to have a diameter substantially equivalent to that of the aperture 55 of the audio input port 40. Although the first and second media input slots 102, 104 and the audio input slot 106 are shown in FIGS. 1 and 5 as being on the side of the rectangular housing 12, this is by way of example only and not of limitation. These access slots may be variously positioned about the housing 12. Furthermore, other shapes, profiles, and configurations of the housing 12 are deemed to be within the scope of the present invention.

According to another embodiment, the digital picture frame 10 includes a decorative frame 108 interchangeably attachable to the housing 12. In further detail, the decorative frame 108 is defined by an outer boundary 110 and an inner boundary 112. The decorative frame 108 is sized and shaped such that the inner boundary 112 thereof is substantially coincident with the interior edge 92 of the housing 12, such that the display screen 14 remains unobstructed. The face of the decorative frame 108 is contemplated as being variously colored, patterned and/or themed. Such decorative elements may be pre-applied or applied by the user.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. An apparatus for displaying digital image data comprising:
a display panel of a plurality of rows and columns of pixels, a selected ones of the pixels being activatable to form a visual representation of the digital image data;
a memory module for storing the digital image data;
an image processing unit for converting the digital image data to a display signal, the display signal being transmitted to the display panel for activating the selected ones of the pixels;
an audio input port receptive of a peripheral audio connector in electrical communication with an external signal source; and
an audio transducer connected to the audio input port, a first audio signal from the external signal source being acoustically reproducible by the audio transducer.

2. The apparatus of claim 1, wherein the memory module is a removable media device, the apparatus further comprising:
a media reader receptive of the removable media device, the digital image data stored on the removable media device being retrieved and transmitted to the image processing unit by the media reader.

3. The apparatus of claim 2, wherein the media reader is receptive of a plurality of form factors of the removable media device.

4. The apparatus of claim 1, further comprising:
an audio processor for converting a digital audio file stored on the memory module to a second audio signal acoustically reproducible by the audio transducer; and
an audio input switch connected to the audio processor and the audio input port, the sound reproduced by the transducer being selectable between the first audio signal generated by the external signal source and the second audio signal generated by the audio processor.

5. The apparatus of claim 1, further comprising:
an adjustable amplifier for controlling the volume of sound reproduced by the audio transducer, the amplifier having an input in electrical communication with the audio input port and an output connected to the audio transducer.

6. The apparatus of 5, wherein the first audio signal is line-level.

7. The apparatus of claim 1, wherein the external signal source amplifies the first audio signal to a transducer driver level.

8. The apparatus of claim 1, wherein the digital image data is representative of at least one static image.

9. The apparatus of claim 1, wherein the digital image data is representative of a plurality of sequenced image frames of video.

10. The apparatus of claim 1, wherein the peripheral audio connector is a tip-ring-sleeve connector.

11. The apparatus of claim 2, further comprising:
an enclosure for housing the display panel, the media reader, the image processing unit, the audio input port and the audio transducer.

12. The apparatus of claim 11, wherein:
the plurality of pixels defines an active display region having an outer edge; and
the enclosure defines a slotted front face having an interior edge substantially coincident with the outer edge of the display panel active display region.

13. The apparatus of claim 12, further comprising:
an interchangeable decorative frame defined by an outer boundary and an inner boundary substantially coincident with the interior edge of the enclosure.

14. The apparatus of claim 11, wherein the enclosure defines a media input slot providing access for the removable media to the media reader.

15. The apparatus of claim 11, wherein the enclosure defines a circular audio input slot for the peripheral audio connector to access the audio input port.
